(19) United States
(12) Patent Application Publication
(10) Pub. No.: US 2003/0105599 A1
(43) Pub. Date: Jun. 5, 2003

(54) System for ensuring proper completion of tasks

(76) Inventors: Craig Brett Fisher, Surrey (CA); Jason Richard Light, Richmond (CA); Michael Douglas Gerty, Vancouver (CA); Neil Garfield Allyn, Vancouver (CA); Chui See Cecilia Tang, Vancouver (CA)

Correspondence Address: NORMAN M. CAMERON, SUITE 1401 - 1166 ALBERNI STREET, VANCOUVER, BC, V6E 3Z3, CA

(21) Appl. No.: 09/996,958

(22) Filed: Nov. 30, 2001

(51) Int. Cl. G01L 1/00; G01L 5/00; G06F 19/00; G01L 3/00

(52) U.S. Cl. 702/41

(57) ABSTRACT

An apparatus ensures proper completion of a plurality of tasks at the plurality of positions, such as torquing of a plurality of bolts on a structure. The bolts are to be torqued to a plurality of different torques. The apparatus includes first indicia adjacent to each bolt. The indicia are characteristic of the torque to which each bolt is to be tightened. There is a reading device for reading the indicia for each bolt. At least one torque wrench is provided for tightening each bolt. The second indicia are operatively coupled to the wrench and to the reading device which indicates when the torque wrench properly tightens each bolt.

### BACKGROUND OF THE INVENTION

This invention relates to devices for ensuring proper completion of tasks such as tightening of bolts and other fasteners, for example when mounting components on CNC machines.

CNC (computer numerical control) machines are used for machining parts from materials, such as steel and aluminum, according to programs entered by trained machinists. However machine operators and machine tenders with less training usually load and unload parts. Some such machines use specialized fixtures to hold one or more workpieces. The workpieces may be blanks cut from bar stock, castings or partially completed parts. The fixtures hold these workpieces while they are machined.

Occasionally parts are loaded improperly onto the fixtures. An improperly loaded pallet may have parts in the wrong place, improperly positioned parts or improperly torqued bolts. This can result in parts which are out of specification, a broken fixture or a broken CNC machine.

The workpieces are typically mounted on the fixtures by a plurality of bolts. These bolts must be torqued to a number of different torques for proper tightening. Improperly tightened bolts may result in an improperly loaded palette with the negative consequences described above. For some fixtures there may be, for example, seven different torque settings for the different bolts. It is up to the operator to properly set the torque for each bolt from a list. This leaves an opportunity for an incorrect torque to be applied to fixture bolts. Since most of the fixtures have many bolts, it is easy for the operator to forget which have been tightened and which have not. Since it can be difficult to tell whether or not a part is properly positioned, fixtures with improperly positioned parts can easily be loaded into a machine.

Double checking bolt torques is one approach to the problem, but decreases productivity. Accordingly there is a need for an improved system for properly ensuring bolts for the above application and other situations where a plurality of bolts must be torqued to different torque levels.

The prior art reveals an air tool, marketed by Uryu, which counts on/off pulses, when the air tool starts and when the torque setting is reached. The number of on/off pulses is normally indicative of the number of bolts which have been tightened. Accordingly the device in theory ensures that the operator has tightened the proper number of bolts. However these devices are disadvantageous in certain respects. For example, the Uryu tool may not sense that the bolt is cross threaded because the time to torque up is too short. Also the device cannot tell if an operator has loosened a bolt after it is tightened. If this has occurred then the number of on/off cycles is not indicative of the number of bolts which have been tightened and accordingly gives rise to the possibility that some bolts remain loose. Another problem is that this device cannot detect the proper torque setting for a particular bolt. It is still up to the operator to choose the correct torque wrench for each bolt. If the wrong wrench is chosen, then the bolt may not be properly tightened.

Japanese Patent No. 2000024945 discloses a radio transmitter in a portable thread fastening tool. This transmits bolting output information of a bolting torque sensor during an assembly operation of workpieces. The output signals confirm that all bolts have been tightened. However there is no disclosure of an individual identification for each bolt. Accordingly the system is subject to error if the worker loosens the bolt and re-tightens it.

Japanese Patent No. 7164343 discloses a wrench with a setting torque sensor which detects the torque set from the voltage value of a variable resistor which is varied by rotation of a setting screw. A completion signal is transmitted when the bolt is properly torqued. The tool ID is transmitted, but there is no disclosure of an ID relating to a specific fastener.

Japanese Patent No. 8141927 discloses a transmitter mounted on a fastening tool which wirelessly transfers screw fastening information. There is no disclosure about fastener-specific information.

U.S. Pat. No. 3,825,912 discloses a torque wrench monitor. There is a circuit which provides an indication each time a fastener has been properly tightened. A first switch is actuated upon initiation of the torquing operation and a second switch is activated upon a predetermined torque output. A signal is provided if the elapsed time between the actuation of the two switches is greater than a predetermined minimum.

U.S. Pat. Nos. 5,226,765 and 5,291,789 disclose bolts with integral load indicators. These appear to be designed to give a signal when the stress of a fastener exceeds a predetermined amount.

U.S. Pat. No. 5,181,575 discloses an impact wrench with a torque controlling faculty.

The prior art does not reveal any fastening tightening systems which keep track of individual fasteners requiring different torque settings.

Accordingly, it is an object of the invention to provide an improved apparatus for ensuring proper completion of a plurality of tasks at a plurality of positions.

It is another object of the invention to provide an improved system for ensuring tightening of fasteners which can sense the torque requirements of different fasteners which require torquing to different torque levels.

It is also an object of the invention to provide an improved system for ensuring tightening of fasteners which can indicate when a particular torque wrench is appropriate to tighten a particular fastener.

### SUMMARY OF THE INVENTION

According to one aspect of the invention there is provided an apparatus for ensuring proper completion of a plurality of tasks at a plurality of positions. The apparatus comprises first indicia adjacent to each position. The indicia are characteristic of a task requiring completion at said each position. There is a reading device for reading the indicia for said each position and at least one tool for carrying out the task. The tool has second indicia operatively coupled to the tool and to the reading device which indicates when the task is properly completed at said each position.

According to another aspect of the invention there is provided an apparatus for ensuring proper torquing of a plurality of bolts on a structure, wherein the bolts are to be torqued to a plurality of different torques. The apparatus comprises first indicia adjacent to each bolt, the indicia being characteristic of the torque to which said each bolt is to be tightened. There is a reading device for reading the indicia for said each bolt and at least one torque wrench having second indicia operatively coupled to the wrench and to the reading device which indicates when the torque wrench is preset for properly tightening said each bolt.

The first indicia may be a resistor and the reading device may include a resistance measuring device.

The apparatus may alternatively include a radio frequency identification device and the reading device may include an antenna.

The invention offers significant advantages over the prior art. In particular, the invention is capable of individually recognizing different bolts or other fasteners which require tightening. Thus the apparatus can determine the proper torque for a particular bolt. The apparatus can then determine whether or not the bolt has been properly tightened. If a particular bolt is loosened and then re-tightened, the unit is capable of keeping track of this instead of possibly indicating the tightening of a new bolt as may occur with the prior art.

### BRIEF DESCRIPTION OF THE DRAWINGS

In the drawings:

FIG. 1 is an isometric view of an apparatus for ensuring tightening of fasteners, according to an embodiment of the invention, and a structure having a plurality of bolts to be tightened by the apparatus;

FIG. 2 is an isometric view of another structure having a plurality of bolts to be tightened, the bolts being fitted with resistors characterizing the torque settings for the bolts;

FIG. 3 is another isometric view of the structure of FIG. 2 shown connected to an apparatus for ensuring tightening of fasteners, according to another embodiment of the invention, illustrated with a torque wrench tightening one of the bolts on the structure;

FIG. 4 is an isometric view of the control panel for the apparatus of FIG. 3 and a wrench holder connected thereto;

FIG. 5 is a fragmentary isometric view thereof showing the connector for the cable connected thereto;

FIG. 6 is an isometric view of the electronics module thereof;

FIG. 7 is an interior isometric view thereof;

FIG. 8 is an isometric view of one of the bolt heads thereof including a bolt extension having indicia for indicating proper torquing of the bolt;

FIG. 9 is a sectional isometric view of the bolt extension thereof;

FIG. 10 is an isometric view showing the bolt and bolt extension of FIG. 8 and a wrench socket for tightening thereof;

FIG. 11 is a sectional isometric view of the wrench socket of FIG. 10;

FIG. 12 is a fragmentary view of the wrench socket mounted on a torque wrench;

FIG. 13 is an isometric view of the torque wrench of the apparatus of FIG. 3;

FIG. 14 is a wiring diagram thereof;

FIG. 15 is a schematic diagram of the voltage reading bridge thereof;

FIG. 16 is an isometric view of an apparatus for ensuring tightening of fasteners including a wrench, according to another embodiment of the invention, and a structure having a bolt to be tightened by the apparatus and an RFID transponder adjacent to the bolt;

FIG. 17 is a top, rear isometric view of the wrench of FIG. 16;

FIG. 18 is a side, rear isometric view thereof;

FIG. 19 is an exploded, isometric view thereof;

FIG. 20 is a flowchart showing the operation of the overall system for the apparatus of FIGS. 16-19;

FIG. 21 is a flowchart showing the initialization mode thereof;

FIG. 22 is a flowchart showing mode selection thereof;

FIG. 23 is a flowchart showing the various modes of operation thereof;

FIG. 24 is flowchart showing the preset torque mode thereof;

FIG. 25 is a flowchart showing the RFID mode thereof;

FIG. 26 is a flowchart showing the readout mode thereof;

FIG. 27 is a flowchart showing the data download mode thereof; and

FIG. 28 is a flowchart showing the sleep mode thereof.

### DETAILED DESCRIPTION OF THE PREFERRED EMBODIMENTS

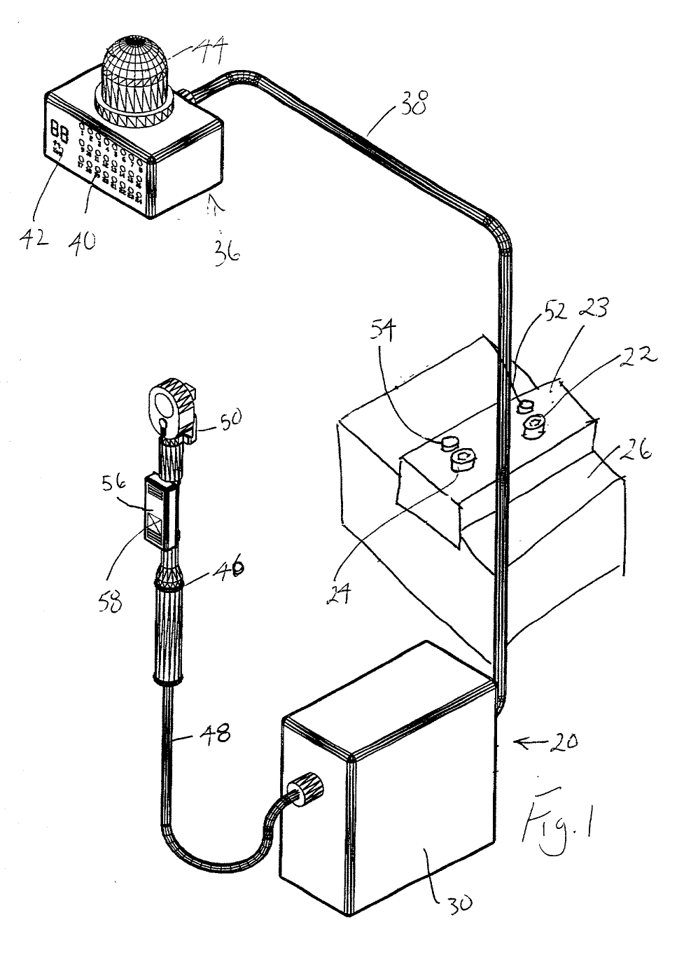

Referring to the drawings, and first to FIG. 1, this shows an apparatus 20 for ensuring proper tightening of fasteners, such as bolts 22 and 24 mounted on a structure 26. The bolts are used to connect a workpiece 23 to the structure 26. The structure 26 in this example is a fixture which holds the workpiece 23 while it is machined. The bolts must be properly torqued to ensure that the workpiece is adequately secured while it is machined to ensure proper machining and to prevent damage to the tool as well as the equipment used to operate the tool, such as a CNC machine. In this example the bolts 22 and 24 must be torqued to different torques. The illustration is a simplification and in other applications there would be many more bolts requiring a number of different torque settings.

The apparatus 20 includes a control module 30 which is equipped with a programmable logic controller (PLC) programmed to keep track of each of the bolts 22 and 24, the proper torque setting for each of the bolts and whether or not the bolts have been properly tightened. If a bolt is loosened, the PLC takes account of the fact. The control module is generally similar to the control module of the alternative embodiment disclosed below and accordingly will not be described in more detail.

There is a display module 36 connected to the control module 30 by a cable 38. The display module includes a plurality of lights 40, a total of twenty-four being included in this embodiment. Two of the lights are associated with the bolts 22 and 24, the remaining lights being used for other such bolts. The lights are illuminated when the bolts are properly tightened. There is an LED display 42 which indicates the proper torque for the bolts being tightened. A large light 44 illuminates, and an audible signal sounds, when a bolt is overtightened.

The control module 30 is connected to torque wrench 46 by a cable 48. This embodiment utilizes a radio frequency identification device (RFID) to identify a particular bolt and to ensure that each bolt is properly tightened RFID's include three main components. There is an RFID tag (often called a transponder or RF tag) which is somewhat equivalent to the printed label of a bar-code system. This is the “data carrier” of the system. Tags can be passive or active. The most common type is the passive tag, which does not have an onboard power supply, but rather extracts its power from incoming radio waves. This type of tag is utilized in this example although active tags could be used in alternative embodiments.

The next main component is an RFID coupler which includes electronics to interrogate and write to the tags. Its main components are a transceiver to transmit and receive power and data as electromagnetic radio waves, and a decoder to decode the information that is stored in the tags. The coupler is contained within the control module 30 in this example.

The device also includes an antenna which serves as the connection between the coupler and the tag. The coupler transmits a power signal and data signals to the tag and receives data from the tag through the antenna. The range of the antenna should be tuned so it picks up only one tag at a time.

The RFID system of this example utilizes components manufactured by Gemplus Corporation in their Gemplus Gem Wave 13.56 MHz RFID System, although other components sourced from other manufacturers could be used in other examples. The Gemplus components are available from Instruments & Equipment Company of 2 Wilson Drive, Unit No. 1, Sparta, N.J. 07871, U.S.A. Suitable tags are part numbers 40SM or 40DM. Suitable antennas, depending upon the application, are part numbers A-VSA, A-SA or A-SF. The couplers can be chosen from part numbers S011, CP11 or S001.

The torque wrench is equipped with an antenna 50 which receives information from a tag associated with each of the bolts, for example tags 52 and 54 which are located adjacent to bolts 22 and 24 respectively. The range of the antenna is typically 1-3 cm although this could vary in other examples.

The torque wrench includes torque-sensing strain gauges which accurately detect the torque applied by the wrench. The torque wrench also has a display module 56 including an LED display 58 having three different colored lights that illuminate as a bolt is tightened. As the torque applied gets closer to the proper torque for the particular bolts, the lights go from red, to yellow, to green. When the light turns green, the bolt has been tightened to the proper torque. Thus the operator can use the same wrench for a range of different torque settings. There is an alarm incorporated into the control module 30 which signals if the bolt is overtightened. The PLC requires the bolt to be loosened before the process continues.

In use, the operator fits the torque wrench onto the head of each bolt. For example, the operator may fit the torque wrench to the head of bolt 22. Antenna 50 receives information from tag 52 indicating the identity of a bolt and its proper tightening torque. This torque is set on the wrench and the operator in this example manually tightens the bolt with the wrench. Alternatively a power tool such as a pneumatic tool may be utilized. When the wrench 46 reaches the proper torque, the display 58 changes color to indicate that the bolt has been properly tightened.

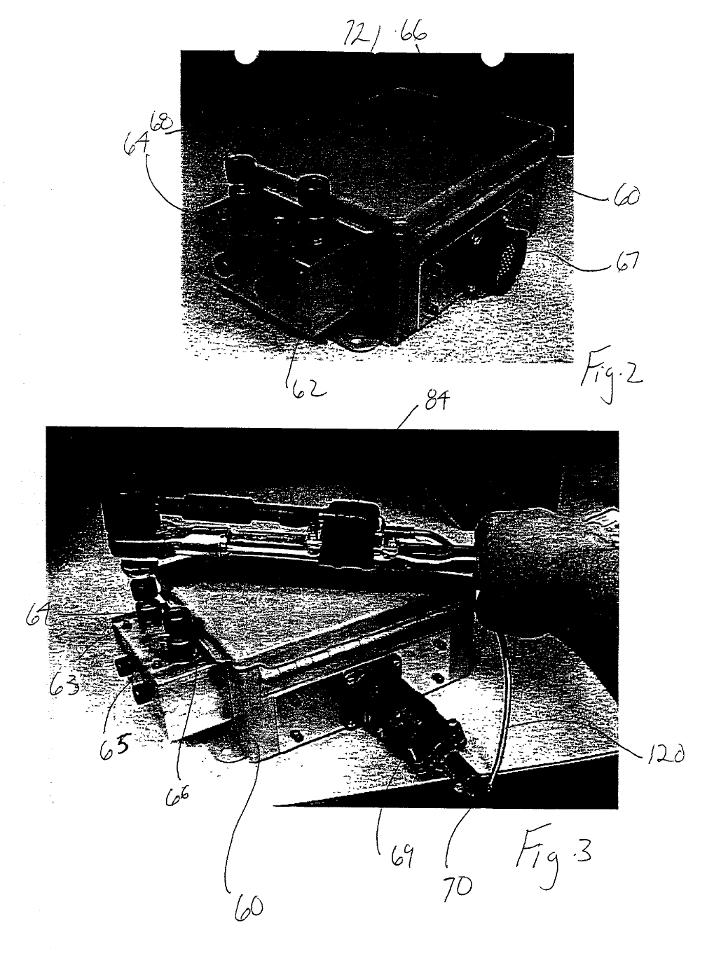

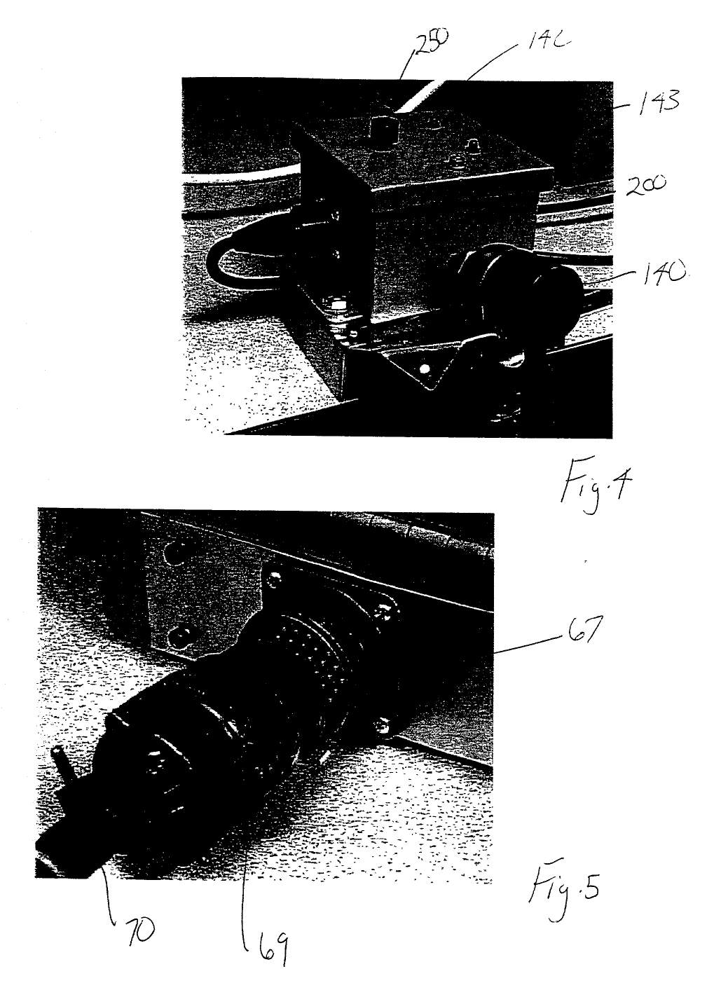

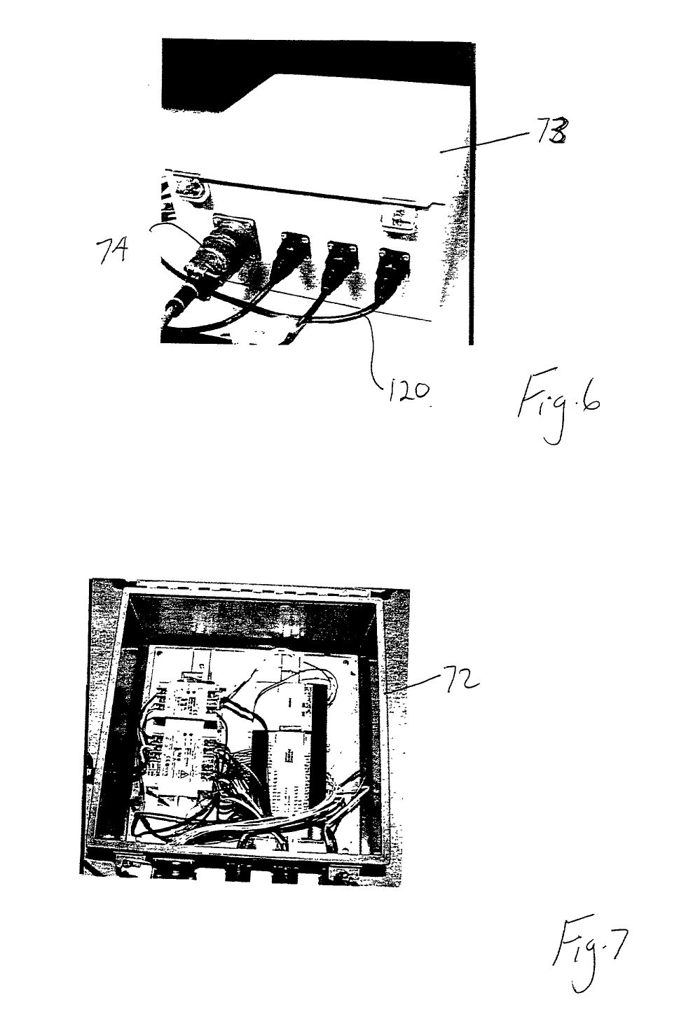

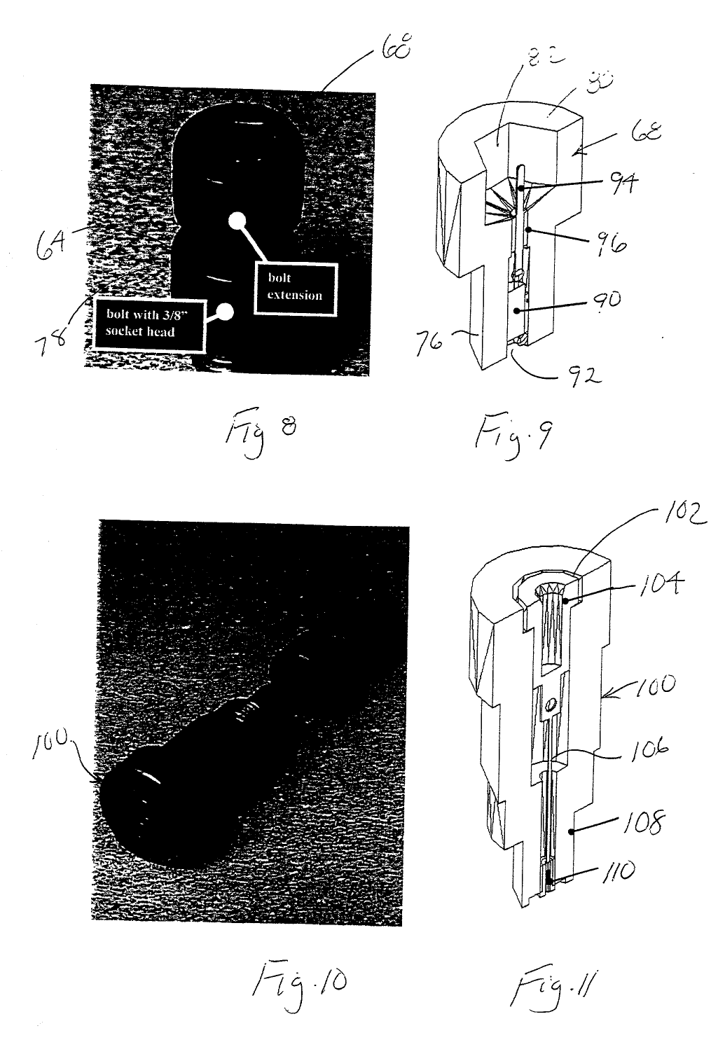

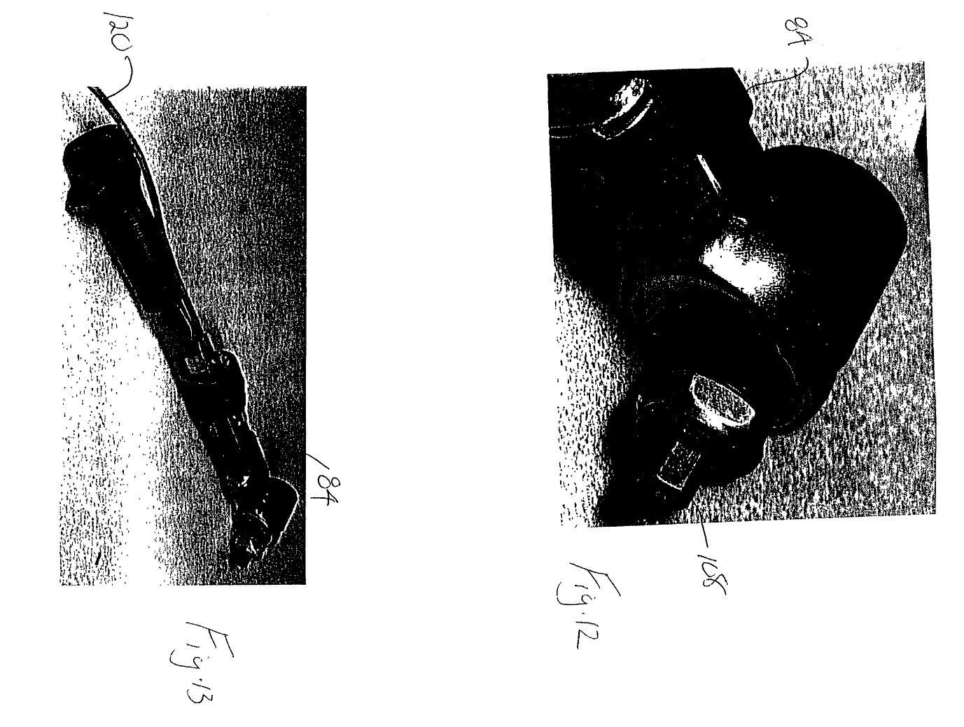

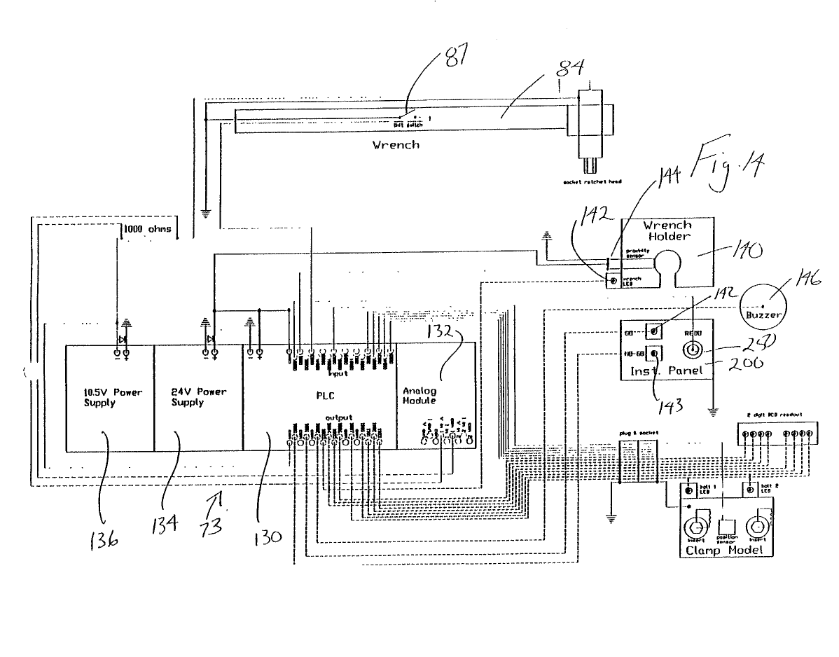

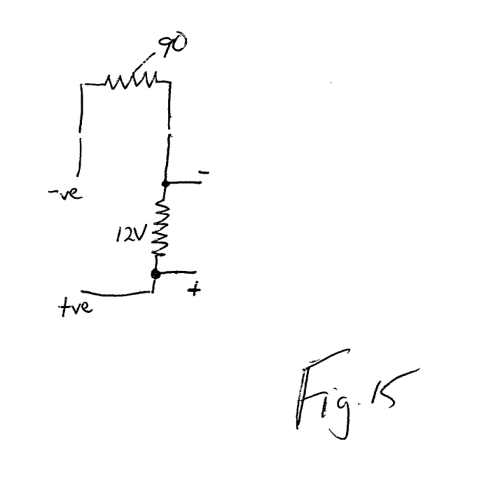

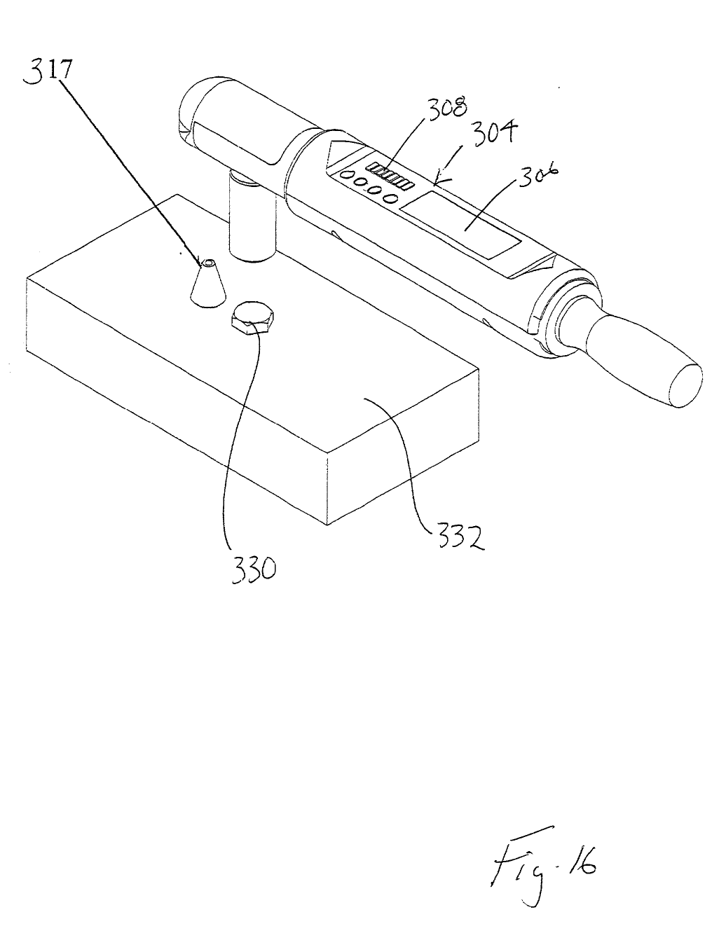

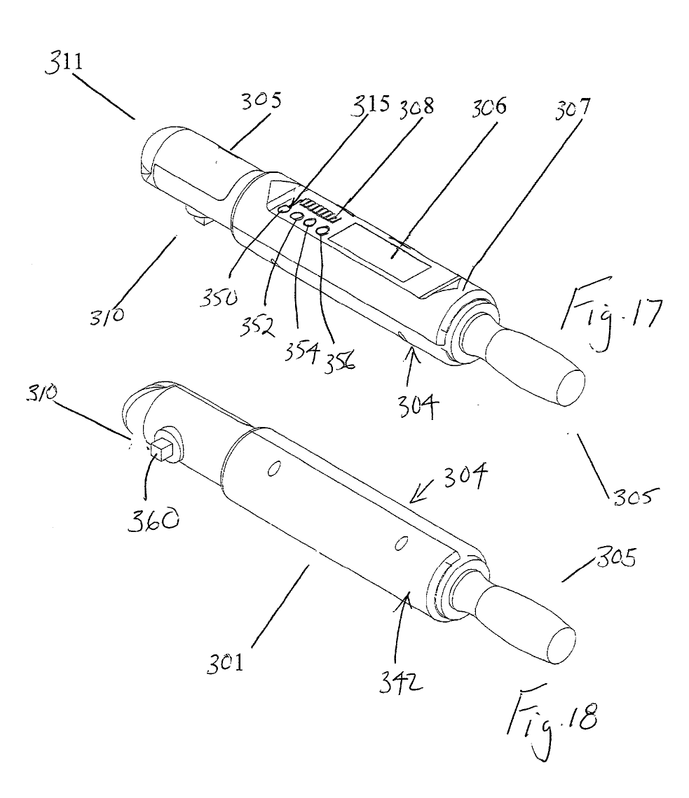

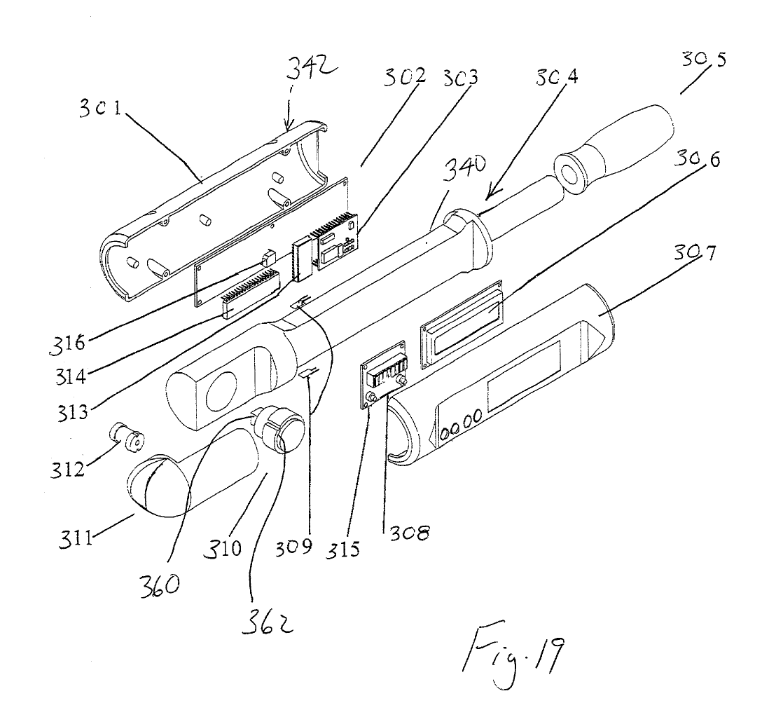

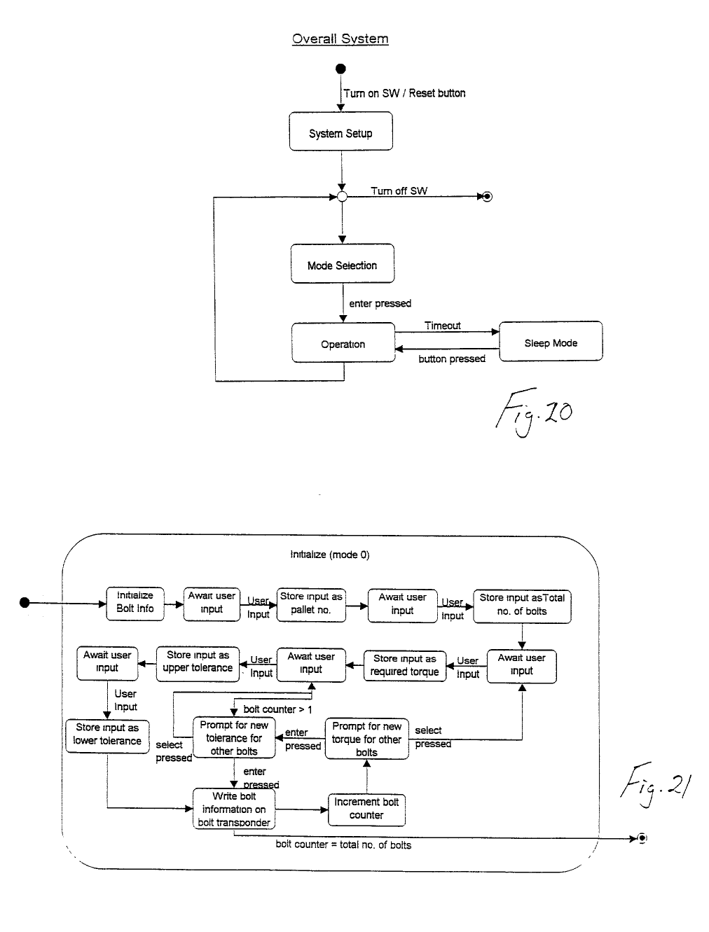

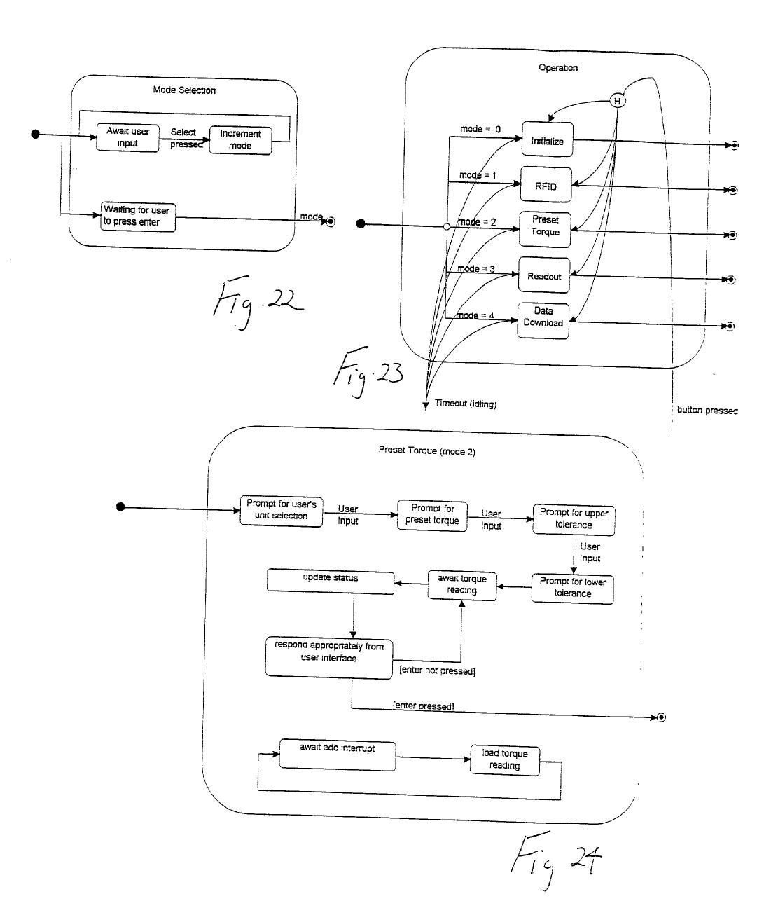

An alternative embodiment is shown in FIGS. 2-14. Fixture 60, shown in FIGS. 2 and 3, has a workpiece 62 connected thereto by bolts 64 and 66. There is an LED 63 and 65 adjacent each of the bolts 64 and 66 as shown best in FIG. 3. There is a multi-pin socket 67 on the side of the fixture which receives plug 69 mounted on cable 70 as shown in FIG. 3 and 5. The opposite end of cable 70 is connected to electronics module 73, shown in FIGS. 6 and 7, by plug 74.

The bolts 64 and 66 are provided with bolt extensions 68 and 72 respectively. These are similar and are shown in better detail for bolt 64 and bolt extension 68 in FIGS. 8 and 9. Bolt extension 68 is provided with a hexagonal shank 76 which fits within hexagonal socket 78 of bolt 64 which is an Allen head bolt in this example. The bolt extension has a head 80 which has a hexagonal socket 82 used to tighten the bolt 64 with torque wrench 84 as shown in FIG. 3. There is a resistor 90 located within central hollow 92 of the shank. A pin 94 is conductively connected to the resistor and extends upwardly into socket 82 through insulator 96. Each bolt has a resistor 90 with a characteristic resistance, thereby individually identifying each bolt.

The torque wrench 84 is provided with a wrench socket 100, shown in FIGS. 10 and 11, for tightening the bolts. The socket has a recess 102 used to connect the socket to the torque wrench. There is an axially retractable member 104 within the socket. The member is connected to a pin 106 which extends slidably through the socket 100 to hex key 108 used to fit the socket 82 on the bolt extension. There is a connector 110 on the bottom of the pin which receives pin 94 of the bolt extension and thereby connects the resistor to the torque wrench.

Cable 120 on the torque wrench is connected to the electronics module 73 as seen in FIG. 6. As seen in FIG. 14, the electronics module includes a PLC 130. The PLC in this example is an Omron PLC which is programmed utilizing a ladder diagram. There is also an analog PLC expansion module 132, a 24 V power supply 134 and a 10.5 V power supply 136. It should be understood that this combination can be varied in other embodiments.

The torque wrench 84 is provided with a switch 87 as shown in FIG. 14. The apparatus includes a wrench holder 140 shown in FIG. 14 and FIG. 4. The wrench holder is mounted on a control panel 200 and is provided with an LED 142, which lights green to indicate when the wrench should be used, and an LED 143, which lights red to indicate when the wrench should not be used. There is also a proximity sensor 144 which indicates when the wrench is in the holder. It should be understood that in other embodiments there may be a series of wrench holders for series of torque wrenches used for different tightening torques. There is also a buzzer 146 adjacent to the wrench holder.

In operation, when fixture 60 is disconnected from plug 69 shown in FIG. 5, and the torque wrench is removed from the holder 140 shown in FIG. 4, buzzer 146 shown in FIG. 14 will sound. Once the plug is plugged into socket 67, shown in FIG. 2, PLC 130 recognizes the fixture and lights the “no go” LED 142, shown in FIGS. 4 and 14, to indicate which wrench to use. The two bolt LEDs 64 and 66 light up and the wrench indicator LED 143.

Once the fixture is plugged in, the wrench may be removed from the holder. When the wrench is placed on one of the bolts, the LED beside that bolt lights to indicate that the system recognizes the bolt. If the wrench is taken out without tightening the bolt, the LED goes back to being on constantly. If the wrench is on one of the bolts and the bolt is tightened until the wrench clicks, the LED corresponding to that bolt will turn off. When both bolts have been tightened and a piece of metal has been placed over the position sensor, which is part of control panel 200 and mounted close to the wrench head cradle, the “no go” light 143 goes off and the “go” LED 142 turns on, indicating that the fixture has been properly loaded.

Reset button 250, shown in FIG. 14 and FIG. 4, may be pressed at any time while the fixture is plugged in. Both LEDs will come back on and system will assume that the bolts have not been tightened.

Another embodiment of the invention is shown in FIGS. 16-18. This includes a wrench 304 used to tighten a bolt 330 on a workpiece 332 having an RFID transponder 317 adjacent to the bolt as seen in FIG. 16. The wrench includes a body 340 and a case 342 in two halves 301 and 307. Within the case is a microcontroller 314, in this case a microchip PIC16F877, and a RFID, a TIRIS RI-STU-MRD1 microreader 303 embedded. A pair of strain gauges 309 are mounted on opposite sides of the body 340. Also mounted on the body is in RFID antenna 312. Also there is an LED array 308, a LCD 306, a series of buttons 315 and a buzzer 316 which are used in the system as a user interface. The wrench has a square key 360 in this example which is connected to a ratchet mechanism 362. The key receives a conventional socket of the size suitable for the bolt being tightened.

The microcontroller 314 receives input signals from other components, processes them and sends appropriate output signals to the user interfacing components identified above. The RFID microreader 303 and antenna 312 are used for identifying the torque settings on bolts, such as bolt 330 in FIG. 16. Adjacent each bolt hole on a fixture, such as workpiece 332 shown in FIG. 16, there is an RFID transponder 317 which contains bolt information. This information includes the pallet number (the number of the pallet on which the fixture or workpiece is mounted), the total number of bolts to be tightened on the pallet, the number of each bolt, torque settings, a time stamp (the time when the bolt was last tightened) and status (under tightened/tightened/overtightened). Other information can be written to the RFID transponder as well.

The microreader 303 reads bolt information from the transponder 17 when the antenna 312 is placed near the transponder 317. In this particular example the microreader reads the bolt information when the antenna is less than 80 mm from the top of the transponder. The microreader transmits the bolt information to the microcontroller 314 for further processing.

The strain gauges 309 are used for torque sensing. When torque is applied to the wrench, strain is induced at the strain gauges. As a result there is a change in the resistance in the strain gauges and the output voltage in the strain gauge circuitry. This voltage is fed to the microcontroller 314 and is compared with the torque settings of the particular bolt. Appropriate actions are then performed.

There are seven LEDs in the array of this embodiment as shown in FIGS. 16 and 17. Four of these are yellow, one green and two red. The LEDs serve two functions. The first is to show the relative relationship between the torque applied to the wrench and the torque required for the particular bolt 330. As the applied torque gets closer to the required torque, the yellow LEDs are turned on one by one. The green LED is turned on when the applied torque is within a specified range of the required torque, in this case ±2%. If the applied torque exceeds this range, then the red LEDs are illuminated. The LEDs also serve to indicate a “go/no go” situation. If the bolt is over or undertightened, then the red LEDs will turn on, warning of this. When the bolt is properly tightened, the green light will be turned on.

The LCD 306 performs most communications with the user. It displays various prompting messages, warning messages, input values and the current applied torque.

Buttons 315 are used as a means for user input. The system has four such buttons in this example. Menu button 350 is for mode selection. Reset button 352 is for system reboot. Select button 354 and enter button 356 have different functions during different modes of operation. In general the select button is used for numerical input and the enter button is used for entry confirmation.

Buzzer 16 is mainly used for warning purposes. However under different modes of operation, the buzz may have different meanings. It may mean that the applied torque exceeds the legitimate range as discussed above or that the wrench is being misused in some other way.

There are six modes of operation of this embodiment as shown in FIG. 23. These are Initialization Mode, RFID Mode, Preset Torque Mode, Constant Torque Readout Mode, Calibration Mode and Data Download Mode. At the beginning, when the system starts up as shown in FIG. 22, the system prompts the user to push the menu button in order to bring up the mode selection menu on LCD 306. Then, using the select button, the user can select the desired mode. Once the system goes through all five modes, it wraps around to the first mode until the user presses the enter button to confirm the user's selection.

Referring to the Initialization Mode, shown in FIG. 21 in more detail, the purpose of this mode is to initialize bolt information in the transponder 317. First the system prompts the user to enter the pallet number, the total number of bolts to be tightened and the torque settings for that particular bolt. Since the bolts on the same pallet may have the same torque settings, the system allows the user to maintain the previous torque settings or to change it. Likewise upper and lower torque tolerance limits are inputted. Internally, the microprocessor 314 initializes the time stamp for that particular bolt by reading the current time and status to be “under tightened”. When all parameters are defined, the system prompts the user to hold the RFID antenna 312 close to the transponder 317 and write the initialized bolt information on the transponder. This procedure is repeated until all the bolts, as specified by the total number of bolts to be tightened, are initialized.

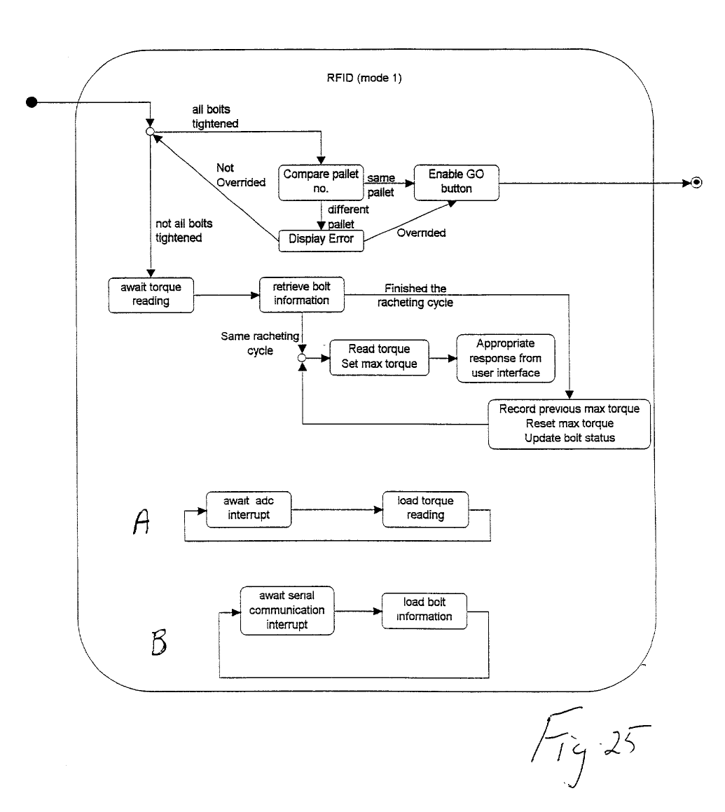

The RFID mode, shown in FIG. 25, makes use of the RFID to obtain the required torque of the bolt to be tightened and checks the current applied torque with respect to the required torque. Upon starting this mode, the time is recorded as a reference to check whether the bolt has been tightened within the current tightening period. This can be done by comparing the time stamp, when the bolt was previously tightened, with the start time of the tightening period. If the time stamp precedes the start time, then the system will update the time stamp of the bolt and reset the status. After recording the start time, information on the bolt of interest is read. Then the time stamp comparison discussed above is performed. After retrieving bolt information, the current applied torque is compared to the required torque. The system will trigger appropriate responses at the user interface to inform the user if the bolt is tightened correctly.

The user is first told by the display in the RFID mode whether all the bolts are tightened or, if not, which are not tightened or are undertightened. If not all are tightened then the wrench is placed near a bolt and the information for the bolt, as identified by the RFID device, is retrieved. When the maximum torque applied to the bolt during the ratcheting cycle equals the preset torque, the bolt does not show up next time as a bolt that needs to be tightened.

When the user has finished tightening all the bolts correctly, the wrench is put into a cradle (not shown) to charge the battery. In one embodiment there is another RFID reader and tag on the pallet itself. The operation of these is shown in the lower portion of FIG. 25. When the pallet comes into a particular bay, the bay therefore “knows” which pallet has come in. There is an antenna at each bay to read this RFID device on the pallet. This system keeps track of which pallet is in which bay so the correct pallet is removed after the bolts are tightened. The go button on the bay is pushed when all of the bolts are tightened and the pallet can be released. The circuit of the wrench will not allow the button to be pushed until the bolts are tightened.

As shown at A in the lower portion of FIG. 25, the torque wrench continuously polls for a torque reading during a torque reading cycle. As shown at B, the wrench polls for tag information during a RFID tag reading cycle. The left-most light on the LED array 308 flashes to show that a correct tag reading has occurred. A and B are interrupts which run anytime during the RFID mode (once there is something external to invoke the interrupt).

The user can proceed by pressing the enter button. Optionally in another embodiment this button is eliminated. The status and the time stamp are then written back to the transponder 317. The whole process is repeated until all of the bolts have been tightened. There is a flag which keeps track of whether the bolt of interest has already been tightened in the same period. If that occurs, then the bolt counter will not increment if the user tightens the bolt again. On the other hand, the bolt counter will decrement if the bolt is undertightened or overtightened. When all of the bolts on a pallet are tightened correctly, then the go button is enabled via RF transmitter 313 and the pallet is transported away for CNC machining in this example.

The preset torque mode, shown in FIG. 24, displays the relative relationship between the current applied torque and the preset torque specified by the user. At the start, it prompts the user to input a preset torque and tolerance range. When the bolt is tightened to a torque close to the preset torque, the LED array 308 shows the relative relationship between the current applied torque and the preset torque. When the torque is close, but less than the preset torque, the yellow LEDs are turned on one by one. When the torque is within ±2% of the preset value, the green LED glows. If the torque exceeds the preset torque, then the red LED's are turned on. Also the buzzer 16 then sounds and appropriate messages are displayed on the LCD. The operation during this mode is similar to prior art devices therefore.

The constant torque readout mode, shown in FIG. 26, constantly displays the current torque that the user has applied to the wrench. This mode can be used to calibrate the wrench or simply to read the applied torque without presets.

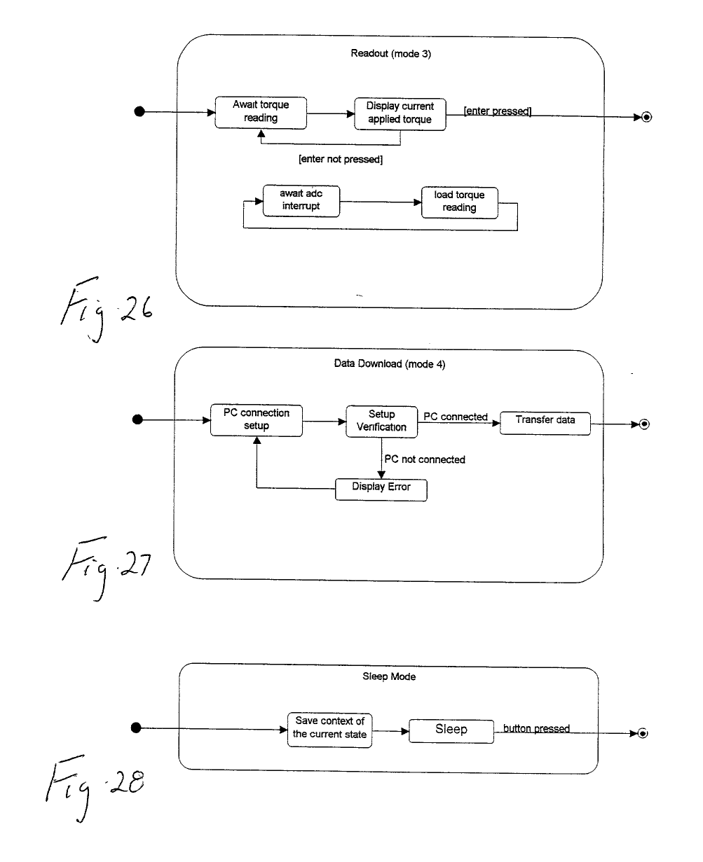

The data download mode is shown in FIG. 27. This mode is used to download data.

Optionally there is also a sleep mode, shown in FIG. 28. The device “goes to sleep” when not used for a preset period of time. The system “wakes up” when one of the buttons on the wrench is pushed. The sleep mode is shown in the context of the overall system in FIG. 20.

This embodiment also includes a number of special features. In order to save energy, the wrench switches to a low-power mode when it has not been used for a certain period of time. The “left-off” state is saved and resumes upon pressing the enter button.

The system supports numerical input from the user. Users can enter the parameters digit by digit, starting from the lowest order digit. Pressing the select button, the numerical value increments and wraps around at 9. In other words, the value following 9 is 0. Pressing enter causes the cursor to move to the next higher order digit. After all the digits are correctly inputted, the user presses the enter button to confirm the input.

In alternative embodiments, there may be more than one go button because there may be more than one bay that the user is going to work on. The wrench of this embodiment is able to identify which bay is currently being worked on and activates the correct go button when all bolts on the pallet in that bay are tightened.

Since there are bolts of different torque settings on a given pallet, wrenches with different ranges of torques need to be employed. Thus the system has to be modified to perform as expected if two or more such wrenches are used on the same pallet. To solve this problem, an external controller is included with such a system. The controller coordinates the actions of all of the wrenches currently being used. Whenever a wrench, according to the invention, is used to tighten a bolt, it communicates with the external controller via RF communication. If some other such wrenches are in use, then the external controller coordinates the actions among them. This ensures that all bolts on a pallet are correctly tightened before further processing even though they are tightened by different wrenches.

On tightening all of the bolts on a pallet, the go button is enabled for further processing. If any bolt on the pallet is not tightened correctly, the wrench displays the identity of the bolt which has not been properly tightened.

The wrench above is able to detect any misthread and stripped thread. If the user applies a torque outside the range of the wrench, the wrench alerts the user. This prolongs the life of bolts, fixtures and the wrench itself.

In an alternative embodiment, a sprag clutch mechanism is used to eliminate any backlash in the wrench. This improves the accuracy of the wrench and ensures that the wrench calibration will last longer. Traditional ratchet type torque wrenches are prone to error due to the large backlash associated with the ratcheting mechanism.

Preferably the firmware of the wrench should be upgradable to enhance the capability of the wrench in future.

The invention has broader applications than bolt tightening. It may be utilized for other types of fasteners which require tightening, such as screws. Also it could be adapted for other types of fasteners such as rivets or clamps which must be cramped, clipped, or clamped in place with a certain tool. In addition, it could be used with dispensers of substances such as thread lockers or lubricants to ensure that the substance is dispensed in the right place. Thus, from a broader point of view, the invention may be regarded as a mistake-proofing system to ensure proper completion of a plurality of tasks at a plurality of positions.

It will be understood by someone skilled in the art that many of the details provided above can be varied or deleted without departing from the scope of the invention which is to be interpreted with reference to the following claims.

What is claimed is:

1. An apparatus for ensuring proper torquing of a plurality of bolts on a structure, wherein the bolts are to be torqued to a plurality of different torques, the apparatus comprising:
first indicia adjacent to each bolt, the indicia being characteristic of the torque to which said each bolt is to be tightened;
a reading device for reading the indicia for said each bolt; and
at least one torque wrench having second indicia operatively coupled to the wrench and to the reading device which indicates when the torque wrench properly tightens said each bolt.

2. The apparatus as claimed in claim 1, wherein the first indicia are characteristic of the identity of the bolt.

3. The apparatus as claimed in claim 1, wherein the first indicia are a resistor and the reading device includes a resistance measuring device.

4. The apparatus as claimed in claim 1, wherein the first indicia include a tag of a radio frequency identification device and the reading device includes an antenna thereof.

5. The apparatus as claimed in claim 1, having a separate said torque wrench for each said different torque.

6. The apparatus as claimed in claim 1, wherein the second indicia include a light on said at least one torque wrench.

7. The apparatus as claimed in claim 1, further including a device for indicating when said each bolt is overtightened.

8. The apparatus as claimed in claim 7, wherein the device for indicating when said each bolt is overtightened includes an audible alarm.

9. An apparatus for ensuring proper completion of a plurality of tasks at a plurality of positions, the apparatus comprising:
first indicia adjacent to each position, the indicia being characteristic of a task requiring completion at said each position;
a reading device for reading the indicia for said each position; and
at least one tool for carrying out the task, the tool having second indicia operatively coupled to the tool and to the reading device which indicates when the task is properly completed at said each position.

10. The apparatus as claimed in claim 9, including a radio frequency identification device which has a RFID tag, an antenna and an RFID coupler, the first indicia being the RFID tag and the reading device including the RFID coupler and the antenna.

11. The apparatus as claimed in claim 10, wherein the antenna is mounted on the tool.

12. The apparatus as claimed in claim 10, wherein the RFID tag is mounted adjacent to the said each position.

13. The apparatus as claimed in claim 10, wherein the tool is a torque wrench in the task is tightening a fastener.

14. The apparatus as claimed in claim 10, wherein the task is connecting a fastener.

15. The apparatus as claimed in claim 10, wherein the task is applying an adhesive.

16. The apparatus as claimed in claim 10, wherein the task is applying a lubricant.

17. The apparatus as claimed in claim 10, including a device for indicating when the task is carried out incorrectly.

18. The apparatus as claimed in claim 17, wherein the device includes an audible alarm.

19. An apparatus for ensuring proper torquing of a bolt on a structure, the apparatus comprising:
a wrench body having a member shaped to receive a tool for tightening the bolt;
a torque sensor for sensing torque applied to the wrench body;
data storage for storing data for the bolt;
an RF transmitter for transmitting data to an RFID device adjacent to the bolt;
an RF receiver for receiving data from the RFID device;
a data processor connected to the torque sensor, the data storage, the RF receiver and the RF transmitter for processing data;
a display device connected to the processor; and
a user input device for inputting data, the user input device being connected to the processor.

20. A method of ensuring proper tightening of bolts on the workpiece, the method comprising:
positioning an RFID device adjacent to each bolt;
recording data on the RFID device indicating the identity of said each bolt;
storing information on the correct torque for each bolt;
tightening said each bolt with a torque wrench having a receiver for receiving data from the RFID specifying the identity of the bolt;
comparing torque applied to the bolt with the correct torque for the bolt; and
providing a signal when the bolt is correctly tightened.

21. The method as claimed in claim 20, wherein the torque wrench has a processor capable of tracking the torquing of a plurality of bolts on a workpiece, and a display which indicates when all of the bolts on the workpiece are correctly torqued.
